(19) United States
(12) Patent Application Publication
(10) Pub. No.: US 2009/0243998 A1
(43) Pub. Date: Oct. 1, 2009

(54) APPARATUS, METHOD AND COMPUTER PROGRAM PRODUCT FOR PROVIDING AN INPUT GESTURE INDICATOR

(75) Inventor: Hao Wang, Beijing (CN)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/057,863

(22) Filed: Mar. 28, 2008

(51) Int. Cl. G09G 5/00

(52) U.S. Cl. 345/156

(57) ABSTRACT

An apparatus, method and computer program product are provided for providing an input gesture indicator. Upon detecting one or more tactile inputs, an electronic device may determine one or more characteristics associated with the tactile input(s) (e.g., number, force, hand pose, finger identity). In addition, the electronic device may receive contextual information associated with the current state of the electronic device (e.g., current application operating on the device). Using the characteristic(s) determined and the contextual information received, the electronic device may predict which operations the user is likely to request, or commands the user is likely to perform, by way of a finger gesture. Once a prediction has been made, the electronic device may display an indicator that illustrates the gesture associated with the predicted operation(s). The user may use the indicator as a reference to perform the finger gesture necessary to perform the corresponding command.

### FIELD

Embodiments of the invention relate, generally, to multi-touch user interfaces and, in particular, to techniques for improving the usability of these interfaces.

### BACKGROUND

It is becoming more and more common for mobile devices (e.g., cellular telephones, personal digital assistants (PDAs), laptops, etc.) to provide touch sensitive input devices or touch user interfaces (UIs) as a compliment to or replacement of the standard keypad. Some of these touch UIs are traditional, single-touch input devices, wherein a user may perform operations on the device via a single tactile input using a stylus, pen, pencil, or other selection device. In addition, many devices now provide a finger-based multi-touch UI, which may provide a more natural and convenient interaction solution for the user.

Multi-touch solutions dramatically increase the number of patterns, or combinations of finger gestures, that can be used to perform various operations on the device. On the one hand, this may be beneficial to the user, since, as indicated above, it may make the user's interaction with the device more natural and convenient. On the other hand, however, the cost of effective recognition of the multi-touch patterns is often not trivial. In addition, it may be difficult for the user to remember all of the different patterns, or combinations of finger gestures, that can be used with his or her device for each of the different applications being operated on the device.

A need, therefore, exists for a way to take advantage of the multiple patterns available in connection with the enhanced finger-based multi-touch UIs, while alleviating the costs associated with recognizing those patterns and assisting the user in his or her use of them.

### BRIEF SUMMARY

In general, embodiments of the present invention provide an improvement by, among other things, providing an interactive selection technique, wherein a prediction may be made as to the operation or command a user is likely to request based on a number of factors, and an indicator may be displayed that illustrates to the user the finger gesture associated with that operation or command. In particular, according to one embodiment, at some point during operation of his or her electronic device (e.g., cellular telephone, personal digital assistant (PDA), laptop, etc.), a user may touch the electronic device touchscreen using one or more of his or her fingers, or other selection devices. In response, the electronic device may first determine one or more characteristics associated with the resulting tactile input detected. These characteristics may include, for example, the number of tactile inputs detected (e.g., with how many fingers, or other selection devices, did the user touch the touchscreen), the amount of force applied in connection with each of the tactile inputs, the user's hand pose (e.g., was the user's hand open, were the user's fingers curving to form a circle, etc.), and/or the identity of the finger(s) used to touch the touchscreen (e.g., thumb, index, middle, ring and/or pinky). In addition, the electronic device may receive contextual information associated with the current state of the electronic device. For example, the electronic device may receive information regarding the current application being operated on the electronic device, the previous one or more operations performed by the electronic device while operating that application, and/or the like.

Using the characteristic(s) determined and the contextual information received, the electronic device may predict which operations the user is likely to request, or commands the user is likely to perform, by way of a finger gesture. In one embodiment, this prediction may involve accessing a look up table (LUT) of certain characteristics and/or states mapped to likely operations or commands. Alternatively, or in addition, various algorithms may be used that may be based, for example, on past operations and sequences of operations performed by the user in different contexts. Once a prediction has been made as to the likely operation(s) to be requested by the user, the electronic device may display an indicator that illustrates the gesture associated with the predicted operation(s). The user may use the indicator as a reference to perform the finger gesture necessary to perform the corresponding command. Based on the foregoing, embodiments of the present invention may assist the user by predicting his or her needs and reducing the number of patterns, or combinations of finger gestures, he or she is required to memorize in order to manipulate his or her electronic device to its fullest extent. Embodiments may further reduce the computational complexity, and, therefore cost, associated with gesture recognition by reducing the pool of gestures to those likely to be performed.

In accordance with one aspect, an apparatus is provided for providing an input gesture indicator. In one embodiment, the apparatus may include a processor configured to: (1) determine a characteristic associated with one or more tactile inputs detected; (2) receive contextual information associated with a current state of the apparatus; (3) identify one or more operations likely to be requested based at least in part on the determined characteristic and the received contextual information; and (4) cause an indicator associated with at least one of the identified operations to be displayed, wherein the indicator illustrates a gesture associated with the identified operation.

In accordance with another aspect, a method is provided for providing an input gesture indicator. In one embodiment, the method may include: (1) determining a characteristic associated with one or more tactile inputs detected; (2) receiving contextual information associated with a current state of the apparatus; (3) identifying one or more operations likely to be requested based at least in part on the determined characteristic and the received contextual information; and (4) causing an indicator associated with at least one of the identified operations to be displayed, wherein the indicator illustrates a gesture associated with the identified operation.

According to yet another aspect, a computer program product is provided for providing an input gesture indicator. The computer program product may contain at least one computer-readable storage medium having computer-readable program code portions stored therein. The computer-readable program code portions of one embodiment may include: (1) a first executable portion for determining a characteristic associated with one or more tactile inputs detected; (2) a second executable portion for receiving contextual information associated with a current state of the apparatus; (3) a third executable portion for identifying one or more operations likely to be requested based at least in part on the determined characteristic and the received contextual information; and (4) a fourth executable portion for causing an indicator associated with at least one of the identified operations to be displayed, wherein the indicator illustrates a gesture associated with the identified operation.

In accordance with another aspect, an apparatus is provided for providing an input gesture indicator. In one embodiment, the apparatus may include: (1) means for determining a characteristic associated with one or more tactile inputs detected; (2) means for receiving contextual information associated with a current state of the apparatus; (3) means for identifying one or more operations likely to be requested based at least in part on the determined characteristic and the received contextual information; and (4) means for causing an indicator associated with at least one of the identified operations to be displayed, wherein the indicator illustrates a gesture associated with the identified operation.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of an electronic device having a multi-touch user interface in accordance with embodiments of the present invention;

FIG. 2 is a schematic block diagram of a mobile station capable of operating in accordance with an embodiment of the present invention;

FIG. 3 is a flow chart illustrating the process of providing an input gesture indicator in accordance with embodiments of the present invention; and

FIGS. 4A-5B provide examples of input gesture indicators displayed in accordance with embodiments of the present invention.

### DETAILED DESCRIPTION

Embodiments of the present invention now will be described more fully hereinafter with reference to the accompanying drawings, in which some, but not all embodiments of the inventions are shown. Indeed, embodiments of the invention may be embodied in many different forms and should not be construed as limited to the embodiments set forth herein; rather, these embodiments are provided so that this disclosure will satisfy applicable legal requirements. Like numbers refer to like elements throughout.

### Electronic Device:

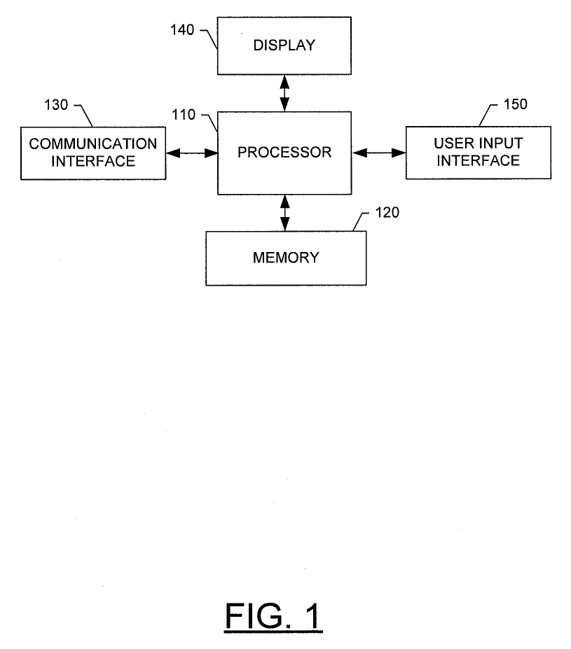

Referring to FIG. 1, a block diagram of an electronic device (e.g., cellular telephone, personal digital assistant (PDA), laptop, etc.) having a multi-touch user interface in accordance with embodiments of the present invention is shown. The electronic device includes various means for performing one or more functions in accordance with embodiments of the present invention, including those more particularly shown and described herein. It should be understood, however, that one or more of the electronic devices may include alternative means for performing one or more like functions, without departing from the spirit and scope of the present invention. As shown, the electronic device can generally include means, such as a processor 110 for performing or controlling the various functions of the electronic device.

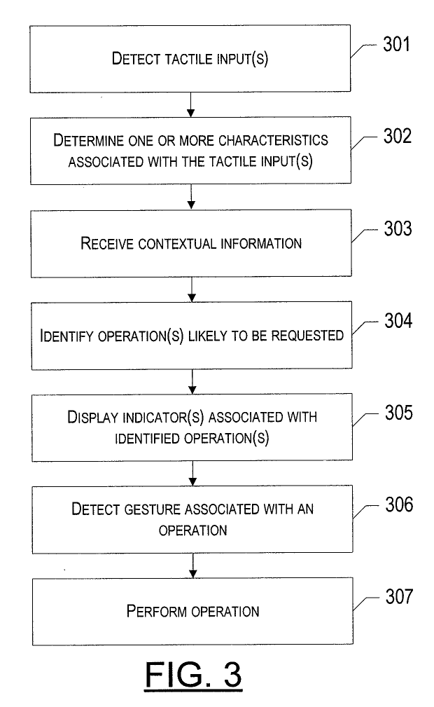

In particular, the processor 110, or similar means, may be configured to perform the processes discussed in more detail below with regard to FIG. 3. For example, according to one embodiment, the processor 110 may be configured to determine a characteristic associated with one or more tactile inputs detected by the electronic device including, for example, the number of tactile inputs, a force associated with respective tactile inputs, a hand pose associated with the tactile inputs, and/or the identity of the fingers associated with the tactile inputs (e.g., thumb, index, middle, etc.). The processor 110 may be further configured to receive contextual information associated with the current state of the electronic device. This may include, for example, the identity of the application(s) currently operating on the electronic device, one or more previous operations preformed by the user, and/or the like.

The processor 110 may be configured to then identify one or more operations likely to be requested by the user based at least in part on the determined characteristic(s) and the received contextual data. For example, if an image browsing application is currently operating on the device (e.g., as indicated by the contextual information) and it is determined that the user touched the touchscreen of the device with two fingers, or other selection device(s) (e.g., stylus, pencil, pen, etc.) (i.e., the characteristic is the number of tactile inputs), the predicted operation likely to be requested by the user may be to scale and/or warp the image currently being viewed. Finally, the processor 110 may be configured to then cause an indicator associated with the identified operation to be displayed, wherein the indicator illustrates a gesture associated with the identified operation. In other words, the indicator shows the user which gesture he or she needs to perform in order to request performance of the corresponding operation.

In one embodiment, the processor may be in communication with or include memory 120, such as volatile and/or non-volatile memory that stores content, data or the like. For example, the memory 120 typically stores content transmitted from, and/or received by, the electronic device. Also for example, the memory 120 typically stores software applications, instructions or the like for the processor to perform steps associated with operation of the electronic device in accordance with embodiments of the present invention. In particular, the memory 120 may store software applications, instructions or the like for the processor to perform the operations described above and below with regard to FIG. 3 for providing an input gesture indicator.

In addition to the memory 120, the processor 110 can also be connected to at least one interface or other means for displaying, transmitting and/or receiving data, content or the like. In this regard, the interface(s) can include at least one communication interface 130 or other means for transmitting and/or receiving data, content or the like, as well as at least one user interface that can include a display 140 and/or a user input interface 150. The user input interface, in turn, can comprise any of a number of devices allowing the electronic device to receive data from a user, such as a keypad, a touchscreen or touch display, a joystick or other input device.

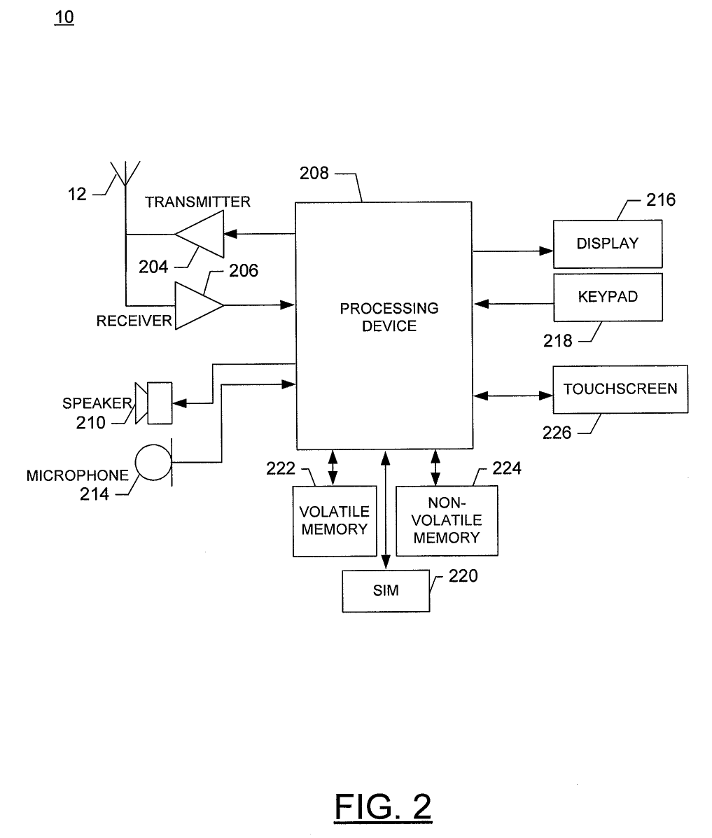

Reference is now made to FIG. 2, which illustrates one specific type of electronic device that would benefit from embodiments of the present invention. As shown, the electronic device may be a mobile station 10, and, in particular, a cellular telephone. It should be understood, however, that the mobile station illustrated and hereinafter described is merely illustrative of one type of electronic device that would benefit from the present invention and, therefore, should not be taken to limit the scope of the present invention. While several embodiments of the mobile station 10 are illustrated and will be hereinafter described for purposes of example, other types of mobile stations, such as personal digital assistants (PDAs), pagers, laptop computers, as well as other types of electronic systems including both mobile, wireless devices and fixed, wireline devices, can readily employ embodiments of the present invention.

The mobile station includes various means for performing one or more functions in accordance with embodiments of the present invention, including those more particularly shown and described herein. It should be understood, however, that the mobile station may include alternative means for performing one or more like functions, without departing from the spirit and scope of the present invention. More particularly, for example, as shown in FIG. 2, in addition to an antenna 202, the mobile station 10 may include a transmitter 204, a receiver 206, and an apparatus that includes means, such as a processing device 208, e.g., a processor, controller or the like, that provides signals to and receives signals from the transmitter 204 and receiver 206, respectively, and that performs the various other functions described below including, for example, the functions relating to providing an input gesture indicator.

As discussed above with regard to FIG. 2 and in more detail below with regard to FIG. 3, in one embodiment, the processing device 208 may be configured to determine a characteristic associated with one or more tactile inputs detected by the mobile station 10; receive contextual information associated with the current state of the mobile station 10; identify one or more operations likely to be requested by the user based at least in part on the determined characteristic(s) and the received contextual data; and to then cause an indicator associated with the identified operation to be displayed, wherein the indicator illustrates a gesture to be performed by the user in order to request the identified operation.

As one of ordinary skill in the art would recognize, the signals provided to and received from the transmitter 204 and receiver 206, respectively, may include signaling information in accordance with the air interface standard of the applicable cellular system and also user speech and/or user generated data. In this regard, the mobile station can be capable of operating with one or more air interface standards, communication protocols, modulation types, and access types. More particularly, the mobile station can be capable of operating in accordance with any of a number of second-generation (2G), 2.5G and/or third-generation (3G) communication protocols or the like. Further, for example, the mobile station can be capable of operating in accordance with any of a number of different wireless networking techniques, including Bluetooth, IEEE 802.11 WLAN (or Wi-Fi®), IEEE 802.16 WiMAX, ultra wideband (UWB), and the like.

It is understood that the processing device 208, such as a processor, controller or other computing device, may include the circuitry required for implementing the video, audio, and logic functions of the mobile station and may be capable of executing application programs for implementing the functionality discussed herein. For example, the processing device may be comprised of various means including a digital signal processor device, a microprocessor device, and various analog to digital converters, digital to analog converters, and other support circuits. The control and signal processing functions of the mobile device are allocated between these devices according to their respective capabilities. The processing device 208 thus also includes the functionality to convolutionally encode and interleave message and data prior to modulation and transmission. The processing device can additionally include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile station may also comprise means such as a user interface including, for example, a conventional earphone or speaker 210, a ringer 212, a microphone 214, a display 316, all of which are coupled to the processing device 208. The user input interface, which allows the mobile device to receive data, can comprise any of a number of devices allowing the mobile device to receive data, such as a keypad 218, a touch-sensitive input device, such as a touchscreen or touchpad 226, a microphone 214, or other input device. In embodiments including a keypad, the keypad can include the conventional numeric (0-9) and related keys (#, *), and other keys used for operating the mobile station and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The mobile station can also include means, such as memory including, for example, a subscriber identity module (SIM) 220, a removable user identity module (R-UIM) (not shown), or the like, which typically stores information elements related to a mobile subscriber. In addition to the SIM, the mobile device can include other memory. In this regard, the mobile station can include volatile memory 222, as well as other non-volatile memory 224, which can be embedded and/or may be removable. For example, the other non-volatile memory may be embedded or removable multimedia memory cards (MMCs), secure digital (SD) memory cards, Memory Sticks, EEPROM, flash memory, hard disk, or the like. The memory can store any of a number of pieces or amount of information and data used by the mobile device to implement the functions of the mobile station. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content. The memory may, for example, store computer program code for an application and other computer programs.

For example, in one embodiment of the present invention, the memory may store computer program code for determining a characteristic associated with one or more tactile inputs detected by the mobile station 10 on the touchscreen or touch display 226 (e.g., number, force, hand pose, finger identity, etc.). The memory may further store computer program code for receiving contextual information associated with the current state of the mobile station 10 (e.g., the application currently being executed, one or more previous operations preformed by user, etc.). The memory may store computer program code for then identifying one or more operations likely to be requested by the user based at least in part on the determined characteristic(s) and the received contextual information, and causing an indicator associated with the identified operation to be displayed, wherein the indicator illustrates a gesture to be performed by the user in order to request the identified operation.

The apparatus, method and computer program product of embodiments of the present invention are primarily described in conjunction with mobile communications applications. It should be understood, however, that the apparatus, method and computer program product of embodiments of the present invention can be utilized in conjunction with a variety of other applications, both in the mobile communications industries and outside of the mobile communications industries. For example, the apparatus, method and computer program product of embodiments of the present invention can be utilized in conjunction with wireline and/or wireless network (e.g., Internet) applications.

### Method of Displaying an Input Gesture Indicator

Referring now to FIG. 3, the operations are illustrated that may be taken in order to provide an input gesture indicator in accordance with embodiments of the present invention. As shown, the process may begin at Block 301, where the electronic device and, in particular, a processor or similar means operating on the electronic device detects one or more tactile inputs as a result of a user touching the electronic device touchscreen or multi-touch user interface (UI) using his or her finger(s) or other selection device(s). The electronic device (e.g., the processor or similar means operating on the electronic device) may detect the tactile input(s) and determine their location via any number of techniques that are known to those of ordinary skill in the art. For example, the touchscreen may comprise two layers that are held apart by spacers and have an electrical current running there between. When a user touches the touchscreen, the two layers may make contact causing a change in the electrical current at the point of contact. The electronic device may note the change of the electrical current, as well as the coordinates of the point of contact.

Alternatively, wherein the touchscreen uses a capacitive, as opposed to a resistive, system to detect tactile input, the touchscreen may comprise a layer storing electrical charge. When a user touches the touchscreen, some of the charge from that layer is transferred to the user causing the charge on the capacitive layer to decrease. Circuits may be located at each corner of the touchscreen that measure the decrease in charge, such that the exact location of the tactile input can be calculated based on the relative differences in charge measured at each corner. Embodiments of the present invention can employ other types of touchscreens, such as a touchscreen that is configured to enable touch recognition by any of resistive, capacitive, infrared, strain gauge, surface wave, optical imaging, dispersive signal technology, acoustic pulse recognition or other techniques, and to then provide signals indicative of the location of the touch.

The touchscreen interface may be configured to receive an indication of an input in the form of a touch event at the touchscreen. As suggested above, the touch event may be defined as an actual physical contact between a selection device (e.g., a finger, stylus, pen, pencil, or other pointing device) and the touchscreen. Alternatively, a touch event may be defined as bringing the selection device in proximity to the touchscreen (e.g., hovering over a displayed object or approaching an object within a predefined distance).

Upon detecting the tactile input(s), the electronic device (e.g., processor or similar means operating on the electronic device) may, at Block 302, determine one or more characteristics associated with the tactile input(s). These characteristic(s) may be determined using techniques that are known to those of ordinary skill in the art. For example, the electronic device (e.g., processor or similar means) may determine the number of tactile inputs, or the number of fingers, or other selection devices, with which the user touched the electronic device touchscreen or multi-touch UI. This characteristic may be useful since different gestures associated with different operations or commands often require a different number of fingers, or other selection devices. As a result, by determining the number of tactile inputs, the electronic device (e.g., processor or similar means) may be able to narrow the number of operations likely to be performed by the user in association with the tactile input(s).

Another characteristic that may be determined is the force associated with each of the detected tactile inputs (e.g., using a touch force sensor in combination with a conductive panel). As with the number of tactile inputs, this characteristic may be useful since different levels of force may be necessary or often used when performing different types of commands. For example, a user may use more force when handwriting words or characters via the touchscreen than when, for example, scrolling, scaling, warping, or performing other, similar, operations.

Alternatively, or in addition, the electronic device (e.g., processor or similar means operating on the electronic device) may determine the user's hand pose, using, for example, one or more cameras and/or an optical sensor array associated with the electronic device and the electronic device touchscreen. Likewise, assuming the user used his or her finger(s) to touch the touchscreen or multi-touch UI, the electronic device (e.g., processor or similar means) may identify which finger(s) he or she used. (See e.g., Westerman, Wayne (1999), “Hand Tracking, Finger Identification, and Chordic Manipulation on a Multi-Touch Surface”). As above with regard to the number and force of the tactile inputs, the identity of the fingers used to touch the electronic device touchscreen may be useful, since different gestures may be more likely to be performed using specific fingers.

In one embodiment, the electronic device (e.g., processor or similar means operating thereon) may further determine the area of contact associated with the tactile input(s). This may indicate, for example, that the user used only the tip of his or her finger to touch the touchscreen and, therefore, is more likely to be performing, for example, a sketch or handwriting operation; or, instead, that he or she used his or her entire finger and, therefore, is more likely to be performing, for example, an erasing or sweeping operation, depending upon the application currently being executed.

In yet another embodiment, the electronic device (e.g., processor or similar means operating thereon) may alternatively, or in addition, determine an angle between the selection device and the screen surface using, for example, a camera and/or sensors positioned at the tip of the selection device. Similar to other characteristics described above, the angle of contact may be useful in narrowing the number of operations likely to be performed by the user in association with the tactile input(s). For example, a different angle of contact may correspond to different types of brushing or painting styles associated with a particular drawing application.

As one of ordinary skill in the art will recognize, the foregoing examples of characteristics that may be determined by the electronic device are provided for exemplary purposes only and should not in any way limit embodiments of the present invention to the examples provided. In contrast, other characteristics may likewise by determined that may be useful in predicting the operations to be performed or commands to be requested by the user and are, therefore, within the scope of embodiments of the present invention.

In addition to the foregoing, according to one embodiment, the electronic device (e.g., processor or similar means operating on the electronic device) may receive, at Block 303, contextual information relating to the current state of the electronic device. This information may include, for example, the identity of one or more applications currently operating on the electronic device (e.g., Internet browser, still or video image viewer, calendar, contact list, document processing, etc.). The information may further include, for example, an indication of one or more operations or commands previously performed by the user when operating within the particular application. For example, the contextual information may indicate that the user is operating a still image viewer and that he or she has recently opened a particular still image. In one embodiment, the contextual information may be received from a state machine (e.g., in the form of a software application or instructions) integrated into the operating system platform of the electronic device or combined with the corresponding application.

As one of ordinary skill in the art will recognize, the foregoing examples of contextual information that may be received by the electronic device are provided for exemplary purposes only and should not in any way limit embodiments of the present invention to the examples provided. In contrast, other types of contextual information may likewise by received that may be useful in predicting the operations to be performed or commands to be requested by the user and are, therefore, within the scope of embodiments of the present invention.

Using the determined characteristic(s) and the received contextual information, the electronic device and, in particular, the processor or similar means operating on the electronic device, may, at Block 304, identify which operation(s) the user is most likely about to or trying to take, or the command(s) he or she is about to or trying to perform, in association with the tactile inputs detected. In other words, the electronic device (e.g., processor or similar means) may attempt to predict what the user would like to do given the action the user has taken at that point and the current state of the device.

In one embodiment, the operation(s) or action(s) may be identified by accessing one or more look up tables (LUTs) that each include a mapping of certain characteristics (e.g. number of tactile inputs, force of respective tactile inputs, hand pose, identity of fingers used, etc.) to possible operations or actions corresponding to those characteristics. To illustrate, Table 1 below provides an example of a LUT that maps the number of tactile inputs, as well as the identity of the fingers used, to various operations or actions.

TABLE 1

| With finger identification | | Without finger identification | |
|---|---|---|---|
| Finger | Widgets | Finger | Widgets |
| Thumb | Eraser, page change, etc. | One contact | Eraser, page change, |
| Index | Mouse (left), pointer, | | Mouse (left), pointer, |
| | paint, etc. | | paint, Mouse (right), etc. |
| Ring | Mouse (right), etc. | | |
| Thumb + Index | Dragging, scaling, | Two contacts | Dragging, scaling, |
| (Ring) | warping, etc. | | warping, Double line, |
| Index + Ring | Double line, mouse | | mouse simulation, etc. |
| | simulation, etc. | | |
| Thumb + Index + Ring | Rotation, compression, | Three | Rotation, compression, |
| | etc. | contacts | etc. |

According to one embodiment, a different set of LUTs may be available for each application or group of applications capable of being executed on the electronic device. Alternatively, a more detailed LUT may be used that incorporates the different applications. According to one embodiment, the LUT(s) may be stored in a database on or accessible by the electronic device.

In addition, or in the alternative, to using the LUTs, in order to identify one or more likely operation(s) or command(s), according to one embodiment, the electronic device (e.g., processor or similar means operating on the electronic device) may perform one or more algorithms that are based, for example, on an historical analysis of previous operations or commands performed by the user in different contexts. In other words, the electronic device (e.g., processor or similar means) may predict what the user may want to do based on what he or she has done in the past in a similar situation. In this embodiment, the electronic device (e.g., processor or similar means operating thereon) may monitor not only the frequency of performance of various operations and commands, but also the succession of operations or commands performed. For example, the sequence may include a plurality of frequently executed operations associated with a particular application being executed on the device in order of the most frequently executed to the least frequently executed. Similarly, the order of a sequence of operations or commands may correspond not only to the frequency of execution or performance, but also the order in which the operations or commands are more frequently executed or performed. According to one embodiment, this information may thereafter assist in predicting the operation(s) the user would like to perform given the characteristics of the tactile input detected and the current state of the electronic device (e.g., what application is currently being executed and/or what operation(s) the user just performed).

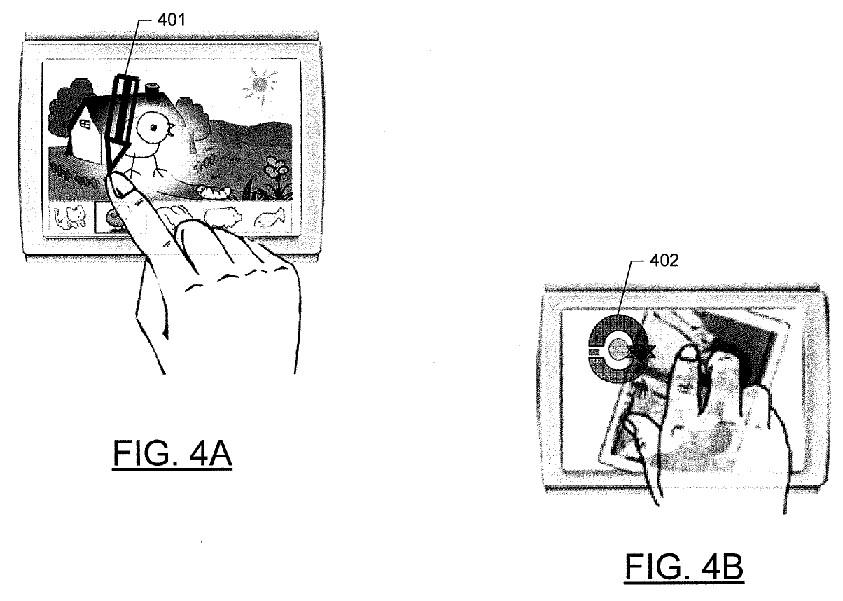

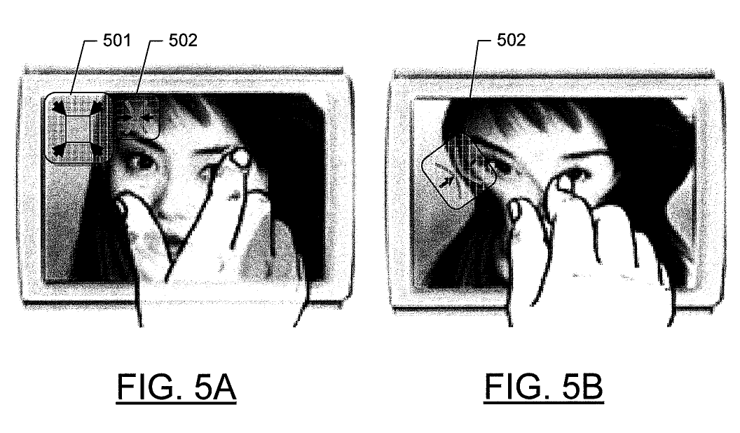

Once the operation(s) likely to be requested by the user have been identified based on the characteristics of the tactile inputs detected and the contextual information received, the electronic device (e.g., processor or similar means operating on the electronic device) may then, at Block 305, display an indicator associated with each of one or more operations determined, wherein the indicator may provide an illustration of the gesture associated with performance of that operation or command by the user. In other words, the indicator may provide a reference that the user can use to perform the gesture necessary to request the corresponding operation or perform the corresponding command. FIGS. 4A through 5B provide examples of indicators that may be displayed in accordance with embodiments of the present invention. As one of ordinary skill in the art will recognize, however, these illustrations are provided for exemplary purposes only and should not be taken in any way as limiting the scope of embodiments of the present invention to the examples provided. In fact, the indicator(s) may be displayed in any number, manner and in any position on the touchscreen in accordance with embodiments of the present invention.

Referring to FIGS. 4A and 4B, in one embodiment, the display of the indicator may be varied based on the context. For example, as shown in FIG. 4A, if the predicted operation is to paint or draw, the indicator may be in the form of a paint brush or pencil 401 that follows the position of the user's finger contacting the touchscreen. As another example, as shown in FIG. 4B, when the predicted operation is to rotate a still image, the indicator may be in the form of a circle having directional arrows 402, wherein the position of the indicator 402 may be fixed and independent of the actual location of the tactile input and wherein the angle of the indicator 402 may indicate the angle to which the image has been rotated. In the latter example, the rotation indicator 402 may have been selected based on some combination of the detection of three tactile inputs, the identification of the thumb, index and middle fingers, and the fact that a still image viewer application is currently being operated.

In one embodiment, the analysis performed at Block 304 may result in only one possible or appropriate operation or command. Alternatively, a number of likely operations or commands may result. In the former instance, the electronic device (e.g., processor or similar means) may display an indicator associated with only the appropriate operation or command. In the latter instance, the electronic device (e.g., processor or similar means operating thereon) may further select from the likely candidates the most likely candidate. This may be based, for example, on a determination of which of the likely operations or commands was most frequently performed by the user in this or a similar situation. The electronic device (e.g., processor or similar means) may thereafter display either only a single indicator associated with the most likely operation or command, or several indicators associated with the likely operations or commands, respectively, with the most likely highlighted in some manner (e.g., by making the indicator associated with the most likely operation or command larger, darker, brighter, etc.). FIGS. 5A and 5B provide one example of how more than one indicator may be displayed. As shown, in this example, the most likely operation identified may be to scale the displayed image, while another likely operation may have been to warp the image. As a result, while indicators may be displayed for both scaling 501 and warping 502, the indicator associated with scaling 501 may be larger than that associated with warping 502.

At some point thereafter, the user may perform a gesture associated with an operation or command, which may be detected by the electronic device (e.g., processor or similar means) at Block 306. In response, the electronic device (e.g., processor or similar means operating thereon) may cause the requested operation or command to be performed. (Block 307). If the prediction made at Block 304 was correct, the gesture detected may correspond to the indicator displayed at Block 305. However, as one of ordinary skill in the art will recognize, embodiments of the present invention are not limited to this particular scenario. Alternatively, the user may perform any gesture which can be recognized by the electronic device (e.g., processor or similar means) and used to trigger a particular operation or command. In the event that the user performs a gesture that does not correspond to a displayed indicator, according to one embodiment, a new indicator may be displayed that corresponds to the gesture currently being or just performed.

Referring again to FIGS. 5A and 5B, in the instance where the user wishes to perform an operation that is associated with one of the indicators displayed, but not the primary indicator (e.g., not the indicator associated with the identified most likely operation), the user may do one of at least two things. According to one embodiment, the user may simply perform the gesture associated with desired operation. Alternatively, the user may first tap the screen at the location at which the indicator associated with the desired operation is displayed, and then perform the corresponding gesture. In either embodiment, as shown in FIG. 5B, the indicator associated with the desired operation, which in the example provided is the indicator associated with warping the image 502, may become the only indicator displayed. Alternatively, while not shown, the other indicators may remain (e.g., that associated with scaling the image 501), but the indicator associated with the operation requested may now be highlighted.

In addition to the foregoing, according to one embodiment, the electronic device (e.g., processor or similar means operating thereon) may instantly update a displayed indicator based on a change in one or more characteristics associated with a detected tactile input. To illustrate, in the example shown in FIGS. 5A and 5B, the scaling and warping operations or commands may have been identified at Block 304 based on some combination of the fact that two fingers were detected, the fingers identified were the thumb and index finger, and the application currently being executed was a still image viewer. If at some point before a gesture is performed, the user adds his or her middle finger to the touchscreen resulting in the change in the characteristics of the detected tactile input, the electronic device (e.g., processor or similar means) may again perform the operation of Block 304 and this time determine, for example, that the most likely operation is to rotate the image. As a result, a new indicator may be displayed that is, for example, similar to that shown in FIG. 4B.

While not shown, according to embodiments of the present invention, the displayed indicator(s) may disappear when the user removes his or her finger(s) or other selection devices from the touchscreen and/or when the user performs the desired gesture.

Based on the foregoing, exemplary embodiments of the present invention may provide a clear indication of desired operations to a user, thus alleviating the burden of remembering multiple gestures associated with various operations or commands. In addition, the indicator may assist a user in making more accurate operations in many instances. For example, with the paint or draw indicator 401 shown in FIG. 4B, the user may be provided with a more accurate position of the drawing point rather than rough finger painting. This may be particularly useful with regard to devices having relatively small touchscreens.

In addition, by using characteristics associated with the tactile input and contextual information to predict the operation(s) likely to be performed by the user, embodiments of the present invention may reduce the computational complexity associated with recognizing finger gestures, since the pool of possible gestures may be significantly reduced prior to performing the recognition process.

### CONCLUSION

As described above and as will be appreciated by one skilled in the art, embodiments of the present invention may be configured as a apparatus and method. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus, such as processor 110 discussed above with reference to FIG. 1, or processing device 208, as discussed above with regard to FIG. 2, to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus (e.g., processor 110 of FIG. 1 or processing device 208 of FIG. 2) to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising:
a processor configured to:
determine a characteristic associated with one or more tactile inputs detected;
receive contextual information associated with a current state of the apparatus;
identify one or more operations likely to be requested based at least in part on the determined characteristic and the received contextual information; and
cause an indicator associated with at least one of the identified operations to be displayed, wherein the indicator illustrates a gesture associated with the identified operation.

2. The apparatus of claim 1, wherein in order to determine a characteristic associated with one or more tactile inputs, the processor is further configured to:
determine a number of tactile inputs detected.

3. The apparatus of claim 1, wherein in order to determine a characteristic associated with one or more tactile inputs, the processor is further configured to:
identify a finger associated with respective tactile inputs.

4. The apparatus of claim 1, wherein in order to determine a characteristic associated with one or more tactile inputs, the processor is further configured to:
determine a force associated with respective tactile inputs.

5. The apparatus of claim 1, wherein in order to determine a characteristic associated with one or more tactile inputs, the processor is further configured to:
determine a hand pose associated with the detected tactile inputs.

6. The apparatus of claim 1, wherein in order to determine a characteristic associated with one or more tactile inputs, the processor is further configured to:
determine at least one of an area of contact or an angle of contact associated with respective tactile inputs.

7. The apparatus of claim 1, wherein the contextual information comprises an identification of an application currently being executed on the apparatus.

8. The apparatus of claim 1, wherein the contextual information comprises an identification of at least one previous operation performed by the processor.

9. The apparatus of claim 1, wherein the processor is further configured to:
receive data associated with one or more sequences of operations previously performed by the apparatus when operating in a similar state as the current state, wherein in order to identify one or more operations the processor is further configured to identify one or more operations based at least in part on the received data.

10. The apparatus of claim 1, wherein the processor is further configured to:
detect a movement of the one or more tactile inputs, wherein said movement corresponds to the gesture associated with the identified operation; and
cause the identified operation to be performed in response to detecting the movement.

11. A method comprising:
determining a characteristic associated with one or more tactile inputs detected;
receiving contextual information associated with a current state of the apparatus;
identifying one or more operations likely to be requested based at least in part on the determined characteristic and the received contextual information; and
causing an indicator associated with at least one of the identified operations to be displayed, wherein the indicator illustrates a gesture associated with the identified operation.

12. The method of claim 11, wherein determining a characteristic associated with one or more tactile inputs further comprises:
determining a number of tactile inputs detected.

13. The method of claim 11, wherein determining a characteristic associated with one or more tactile inputs further comprises:
identifying a finger associated with respective tactile inputs.

14. The method of claim 11, wherein determining a characteristic associated with one or more tactile inputs further comprises:
determining a force associated with respective tactile inputs.

15. The method of claim 11, wherein determining a characteristic associated with one or more tactile inputs further comprises:
determining a hand pose associated with the detected tactile inputs.

16. The method of claim 11, wherein determining a characteristic associated with one or more tactile inputs further comprises:
determining at least one of an area of contact or an angle of contact associated with respective tactile inputs.

17. The method of claim 11, wherein the contextual information comprises an identification of an application currently being executed on the apparatus.

18. The method of claim 11, wherein the contextual information comprises an identification of at least one previous operation performed by the processor.

19. The method of claim 11 further comprising:
receiving data associated with one or more sequences of operations previously performed by the apparatus when operating in a similar state as the current state, wherein identifying one or more operations further comprises identifying the one or more operations based at least in part on the received data.

20. The method of claim 11 further comprising:
detecting a movement of the one or more tactile inputs, wherein said movement corresponds to the gesture associated with the identified operation; and
causing the identified operation to be performed in response to detecting the movement.

21. A computer program product comprising a computer-readable medium having computer-readable program code portions stored therein, the computer-readable program code portions comprising:
a first executable portion for determining a characteristic associated with one or more tactile inputs detected;
a second executable portion for receiving contextual information associated with a current state of the apparatus;
a third executable portion for identifying one or more operations likely to be requested based at least in part on the determined characteristic and the received contextual information; and
a fourth executable portion for causing an indicator associated with at least one of the identified operations to be displayed, wherein the indicator illustrates a gesture associated with the identified operation.

22. The computer program product of claim 21, wherein the first computer-readable program code portion is further configured to at least one of determine a number of tactile inputs detected, identify a finger associated with respective tactile inputs, determine a force associated with respective tactile inputs, determine a hand pose associated with the detected tactile inputs, determine an area of contact associated with respective tactile inputs, or determine an angle of contact associated with respective tactile inputs.

23. The computer program product of claim 21, wherein the computer-readable program code portions further comprise:
a fifth executable portion for determining a force associated with respective tactile inputs, wherein identifying one or more operations further comprises identifying the one or more operations based at least in part on the determined force.

24. The computer program product of claim 21, wherein the computer-readable program code portions further comprise:
a fifth executable portion for determining a hand pose associated with the detected tactile inputs, wherein identifying one or more operations further comprises identifying the one or more operations based at least in part on the determined hand pose.

25. The computer program product of claim 21, wherein the contextual information comprises an identification of an application currently being executed on the apparatus.

26. The computer program product of claim 21, wherein the contextual information comprises an identification of at least one previous operation performed by the processor.

27. The computer program product of claim 21, wherein the computer-readable program code portions further comprise:
a fifth executable portion for receiving data associated with one or more sequences of operations previously performed by the apparatus when operating in a similar state as the current state, wherein identifying one or more operations further comprises identifying the one or more operations based at least in part on the received data.

28. The computer program product of claim 21, wherein the computer-readable program code portions further comprise:
a fifth executable portion for detecting a movement of the one or more tactile inputs, wherein said movement corresponds to the gesture associated with the identified operation; and
a sixth executable portion for causing the identified operation to be performed in response to detecting the movement.

29. An apparatus comprising:
means for determining a characteristic associated with one or more tactile inputs detected;
means for receiving contextual information associated with a current state of the apparatus;
means for identifying one or more operations likely to be requested based at least in part on the determined characteristic and the received contextual information; and
means for causing an indicator associated with at least one of the identified operations to be displayed, wherein the indicator illustrates a gesture associated with the identified operation.
